(19) United States
(12) Patent Application Publication
(10) Pub. No.: US 2013/0181049 A1
(43) Pub. Date: Jul. 18, 2013

(54) STAND SUITABLE FOR SECURING A BAG

(71) Applicant: Jill Aston, Dalkey (IE)

(72) Inventor: Jill Aston, Dalkey (IE)

(21) Appl. No.: 13/811,102

(22) PCT Filed: Jul. 20, 2011
(86) PCT No.: PCT/EP2011/062485

§ 371 Date: Apr. 3, 2013

(30) Foreign Application Priority Data
Jul. 20, 2010 (IE) S2010/0454
Nov. 22, 2010 (GB) 1019735.8

(51) Int. Cl. F16M 11/04; G06K 7/01; H02J 7/00; G09F 3/20

(52) U.S. Cl. CPC F16M 11/04; G09F 3/20; G06K 7/01; H02J 7/0042
USPC 235/439; 248/97; 40/642.02; 320/107

(57) ABSTRACT

A bag stand (1) for securing a bag comprising a base (4), a pole (2) connected to the base (4), and a means for securing the bag, wherein the means for securing the bag is attached to the pole, characterised in that the means for securing the bag comprises at least one supporting means having a pair of clips (10, 11) pivotally secured thereto.

### FIELD OF THE INVENTION

The invention relates to a stand useful for securing a bag. More specifically, the invention relates to a stand for hanging and securing a handbag or any suitable accessory. The invention also relates to a stand for securing a bag and having extra functionality.

### BACKGROUND TO THE INVENTION

When one carries a handbag the problem is always what to do with it when one sits down. If one holds it on ones lap, it gets in the way when one eats. If one puts it on the ground, it gathers bacteria and could be stolen. If one puts it on the back of the chair, it most certainly could be stolen and often is. Some people hook the strap on their knee and spend the entire time checking to make sure it is still present, which takes away from the enjoyment of the occasion.

Some people avail of a portable hook that can be removably attached to a table and place the handbag on the hook on the table. On the next occasion, the person may change their handbag and find that they have left the hook in their other bag. Some sit with the handbag on their shoulder for the entire meal. At an average weight of 5.5 pounds (2.5 Kg), the handbag can be an awkward necessity.

According to research carried out by home insurer Churchill in Great Britain, handbag thefts and losses are costing British women £4.9 bn. Thirty-one percent of those questioned have had their handbag stolen on at least one occasion. On average, every time a handbag is stolen women are faced with, on average, a £228 bill to replace the bag and its contents. These include home and car keys, wallets, make-up and even medication. The research shows that each woman will spend six working days getting new keys cut, contacting banks and mobile phone operators and shopping for new contents. Each handbag contains an average of three credit or cash cards and the research shows that one in ten women (12%) have had money taken from their bank account after their bag disappeared. 72% of women admit they live in fear that their bag will be stolen according to Churchill.

Various systems have been developed, for example as described in WO 2009/023932, which discloses a storage assembly having a stand with holding members connected to the stand at right angles. The document U.S. Pat. No. 5,934,499 discloses a locker box for a beach umbrella, while WO 95/11611 describes the use of a stand having a hook hanger with a notch to permit heavy items to be hung there from. However, the problem associated with the systems described in the above-referenced documents is that neither one of the systems are capable of securing a bag when hung or stored in those systems. The document US 2010/0264280 discloses a table-height bag holder which comprises a series of angled bag hangers attached to a central stand and where the bag hangers may further comprise an impeding structure to prevent removal of the bag from the stand. However, the problem associated with the bag hangers in the US 2010/0264280 document is that a bag hanging from the bag hanger remains accessible and easily removed from the stand by one hand.

It is an object of the invention to provide a stand for securing a bag to overcome at least some of the above-mentioned problems.

### SUMMARY OF THE INVENTION

According to the invention, there is provided, as set out in the appended claims, a bag stand for securing a bag comprising a base, a pole, which is connected to the base, and a means for securing the bag, for example a securing mechanism such as a lock, wherein the securing means is attached to the pole.

One of the advantages of the present invention is that the securing mechanism is tamper proof. Clips which comprise a portion of the securing mechanism allow a person to keep their bag at eye level at all times. Therefore, a meal or social occasion can be enjoyed because the strap on their bag can be seen hanging on the stand beside them. The gives a person peace of mind that their bag is secure, within arm's reach and without having the hassle of supporting what is generally a relatively heavy object to carry around.

A further advantage is that any bag that hangs from the securing mechanism of the stand of the present invention, limits, if not negates, the amount of bacteria that can contaminate a bag that sits on the ground. The bag that sits on the ground tends to also end up sitting on the kitchen countertop therefore spreading bacteria onto food preparation surfaces.

In one embodiment, the means for securing the bag may comprise at least one supporting means, for example a plate, having a pair of clips pivotally secured thereto. The pair of clips may be secured to the plate by a securing means such as a threaded screw. The plate may be secured to the pole by any securing means and further comprises a pair of outwardly curving arms. The arms are generally continuous with the plate and positioned out and away from the pole. The arms may be positioned away from the pole at an angle between about 15° and 75°, preferably between about 35° and 55°, relative to the vertical axis of the pole.

In a further embodiment of the invention, the means for securing the bag may comprise a pair of juxtaposed plates secured together, with the pole generally separating the pair of plates, that is, the plates being either side of the pole.

In one embodiment, the securing means comprise a screw, a bolt, a pin, a ratchet, or any male/female connection system known in the art.

In one embodiment, the clips are arcuate having a shape similar to a stretched and curved teardrop, thereby giving the clip an appearance of a teardrop-like lobe at a first end and a thin lobe at a second end. It is preferable that the teardrop-like lobe be weighted. This arrangement provides for an effective securing means and is aesthetically pleasing to the eye.

In one embodiment of the present invention, the pair of plates may be further secured together by a stop positioned between the arms. The stop acts to prevent the weighted teardrop-like lobe of the clip from reaching its gravitational (natural) equilibrium along the clip's longitudinal (X)-axis. The presence of the stop can further act to prevent the thin lobe of the clip from reaching its natural gravitational equilibrium along its longitudinal (X)-axis. When the clip is allowed to attain its natural position along its longitudinal X-axis, due to the weighted nature of the teardrop-like lobe, the thin lobe of the clip would open the securing mechanism.

In one embodiment of the present invention, when the weighted teardrop-like lobe rests against the stop, the thin lobe of the clip may be juxtaposed the pole of the stand. The combination of the plate, the arm, the clip and the pole form a space-defining secure compartment. It is within this space-defining secure compartment that a handbag or any bag may be placed and secured.

In a further embodiment of the present invention, the stand may further comprise a plinth secured to the top of the pole, and optionally, a decorative object supported by the plinth. The decorative object may be any object selected from the group comprising an orb, a globe, or any shape desired by the user.

The plinth or decorative object may further have a receiving means attached thereto, for example, a pair of hoops joined together at a point which also acts to secure the receiving means to either the plinth or the decorative object. The receiving means may be secured to the plinth or decorative object by spot welding, or any means deemed appropriate by one skilled in the art. The receiving means may be suitable for accommodating a menu, an advertising board for advertising goods and/or services or other commercial pamphlet via, in this instance, a gap between the pair of hoops. Preferably the receiving means is positioned in view such that a person sitting at a table has a clear view of the advertising means. It will be appreciated that the receiving means can be any suitable shape or size.

In a further embodiment of the present invention, the stand may further comprise a receiving means attached to the top of the pole. The receiving means may be in the form of disk or a rectangle shaped area and configured to display information and/or advertising media. The outer edge of either the disk or rectangle may be constructed of either mild steel or wood to provide an aesthetically pleasing appearance to a user. The disk or rectangle may hold two pieces of poly(methyl methacrylate) (PMMA) glass or any transparent material between which the information and/or advertising media may be placed.

In a further embodiment of the present invention, the stand may further comprise a Liquid-Crystal Display (LCD) secured to the top end of the pole.

In one embodiment of the present invention, the liquid crystal display may be an interactive liquid-crystal display (LCD). The liquid-crystal display may optionally further comprise an electronic slotted card swipe for use in making electronic transactions. The interactive LCD screen permits a user using a touch screen interface to select a feature such as, for example, advertisements, flight and travel information, a menu for ordering food and beverages, or an information video. The interactive liquid-crystal display interacts with customers to supply information or shows a menu which a user may follow to use their credit card or debit card, or other transaction means, to facilitate electronic transactions.

In a further embodiment of the invention, the stand may further comprise at least one power cable configured for attaching to and charging an electronic device. At one end of the power cable is a connection configured to matingly engage with the electronic device while at the other end thereof, the power cable is configured to engage with a wall power point. The electronic device may be any device selected from the group comprising a computer, a laptop, a mobile telephone, other telecommunication devices and the like. Optionally, the stand may comprise a plurality of connections configured to matingly engage with an electronic device, each adapted to matingly engage with a specific brand of electronic device, for example, any device from Nokia®, Apple®, Dell®, Blackberry®, Sony®, Panasonic®, Samsung®, and any other brands known to a person of ordinary skill in the art.

The power cable may be threaded through an aperture at the base of the pole and through a central cavity in the pole and exit the pole through an aperture at the top end of the pole. The power cable may be retractable, in that the cable is stored on a spring-loaded spool. The spring-loaded spool is configured to retract the power cable when not in use. When not in use, the connection configured to matingly engage with the electronic device may rest against or may be juxtaposed the aperture at the top end of the pole from which the cable exits.

The height of the pole of the stand of the present invention may be between about 60 cm to about 150 cm, preferably between about 80 cm to about 130 cm, more preferably between about 90 cm to about 115 cm, and ideally about 107 cm.

The area of the base of the present invention may be between about 15 cm² to about 32 cm², preferably about 18 cm² to about 27 cm², more preferably about 20 cm² to about 25 cm², and ideally about 23 cm².

The base of the present invention may take any shape selected from the group comprising a square, a circle, a pentagon, a parallelogram, a hexagon, an octagon, and a decagon. The base may optionally be galvanised with four small protrusions affixed to the underside of the base and manufactured from the group comprising rubber, plastic, metal, heavy cloth, and cork.

The weight of the stand of the present invention may be between about 2.5 Kg to about 10.0 Kg, preferably between 3.5 Kg to about 8.5 Kg, more preferably between about 5 Kg to about 7 Kg, and ideally about 6.63 Kg.

The plate of the present invention may be attached at its lowest point to the pole at between about 15 cm to about 35 cm, preferably between about 20 cm to about 30 cm, and ideally about 24 cm from the top of the pole.

In one embodiment of the present invention, the stand is constructed from any metal or heavy plastic selected from the group comprising mild steel, galvanised steel, brass, and, optionally, may be painted. Another advantage of the present invention is that the stand is too heavy to be picked up and stolen but is small enough to conveniently stand next to a table or chair in a café, restaurant, shop, public house, bar, and any other public building. Due to the nature of the securing mechanism, a user may lift the stand by placing their hands under the thin lobe of the clips and lifting the stand. The stop acts to ensure that the weighted end of the clip cannot travel any further, thus allowing the user to safely lift the stand.

The stand of the present invention is also suitable for use in securing other accessories other than a bag, which area also deemed cumbersome by the user in the same manner as a handbag is, as described above.

According to the invention, there is also provided an advertising stand for securing a bag comprising a base, a pole, which is connected to the base, and a means for securing the bag, for example a securing mechanism such as a lock, wherein the securing means is attached to the pole.

### BRIEF DESCRIPTION OF THE DRAWINGS

The invention will be more clearly understood from the following description of an embodiment thereof, given by way of example only, with reference to the accompanying drawings, in which: —

FIGS. 1A and B shows a side and elevation view, respectively, of the stand of the present invention.

FIG. 2A-C shows a side, elevation and plan view, respectively, of the stand of the present invention.

FIGS. 3A and 3B shows a front view of the stand of the present invention.

FIG. 4 shows a front view of the stand of the present invention.

FIG. 5 shows a side view of the stand of the present invention.

### DETAILED DESCRIPTION OF THE DRAWINGS

When one carries a handbag the question is always what to do with it when one sits down. One can hold it on ones lap; put it on the ground; on the back of the chair; hook the strap on their knee; avail of a portable hook that can be removably attached to a table and placing the handbag on the hook on the table; or sit with the handbag on their shoulder for the entire meal. At an average weight of 5.5 pounds (2.5 Kg), the handbag can be an awkward necessity

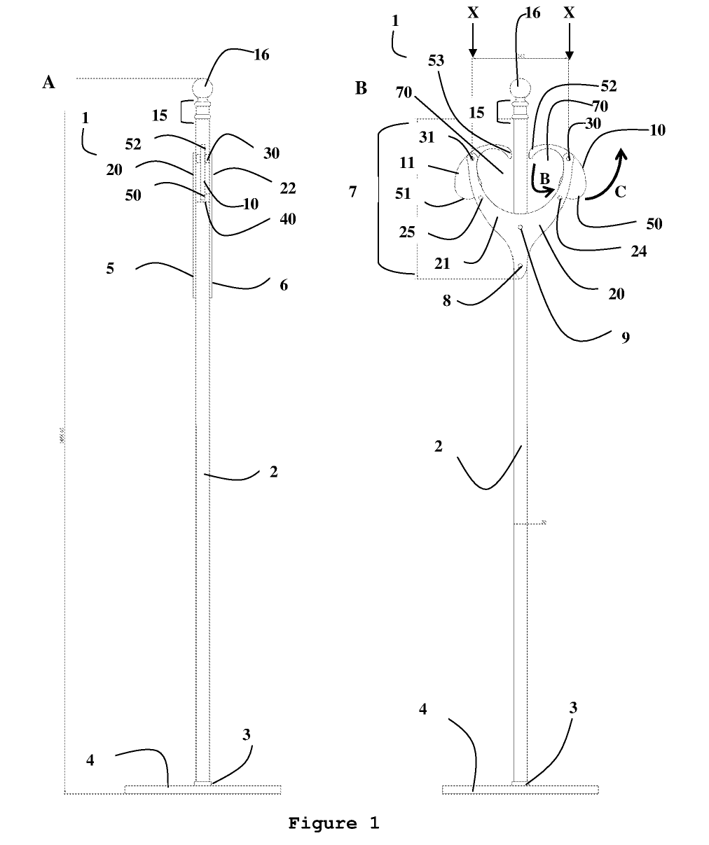

Referring now to the figures, where FIG. 1 illustrates a general embodiment of the present invention. Specifically, FIGS. 1A and B illustrate a side and elevation view, respectively, of a stand of the present invention, which is generally referred to by reference numeral 1. The stand 1 comprises a pole 2 attached at its bottom end 3 to a base 4. A pair of plates 5, 6 is removably secured at a top end 7 of the pole 2 with screws 8, 9. The stand 1 further comprises a pair of arcuate clips 10, 11 pivotally connected between plates 5, 6. The top end 7 of the pole 2 further comprises a plinth 15 upon which a spherical or any shaped object 16 is attached.

The plates 5, 6 each further comprise a pair of outwardly curved arms 20, 21 and 22, 23, respectively, which are positioned away and out from the top end 7 in the form of a standing arch. The arms 20, 21 and 22, 23 are continuous with plates 5, 6, respectively. The clips 10, 11 are pivotally connected between the arms 20, 22 and 21, 23, by pins 30, 31, as shown in FIG. 1A. The pins 30, 31 matingly engage with the clips 10, 11 through a bore in the body of the clips. The clips 10, 11 are free to move pivotally (or to swivel) around the pins 30, 31 through 360°. However, the clips 10, 11 are weighted heavier at ends 50, 51 than ends 52, 53. As such, the centre of gravity of the clips 10, 11 biases the clips 10, 11 to have a position along a longitudinal axis X.

However, this bias would leave ends 52, 53 open. Therefore, a pair of stops 24, 25 are positioned between arms 20, 22 and 21, 23 to prevent the clips 10, 11 from reaching their biased position. The weighted ends 52, 53 rest against stops 24, 25 which positions ends 52, 53 juxtaposed the top end 7 of the pole 2. The juxtaposition of the ends 52, 53 with the top end 7 of the pole 2 forms a secure compartment 70 into which a bag may be placed.

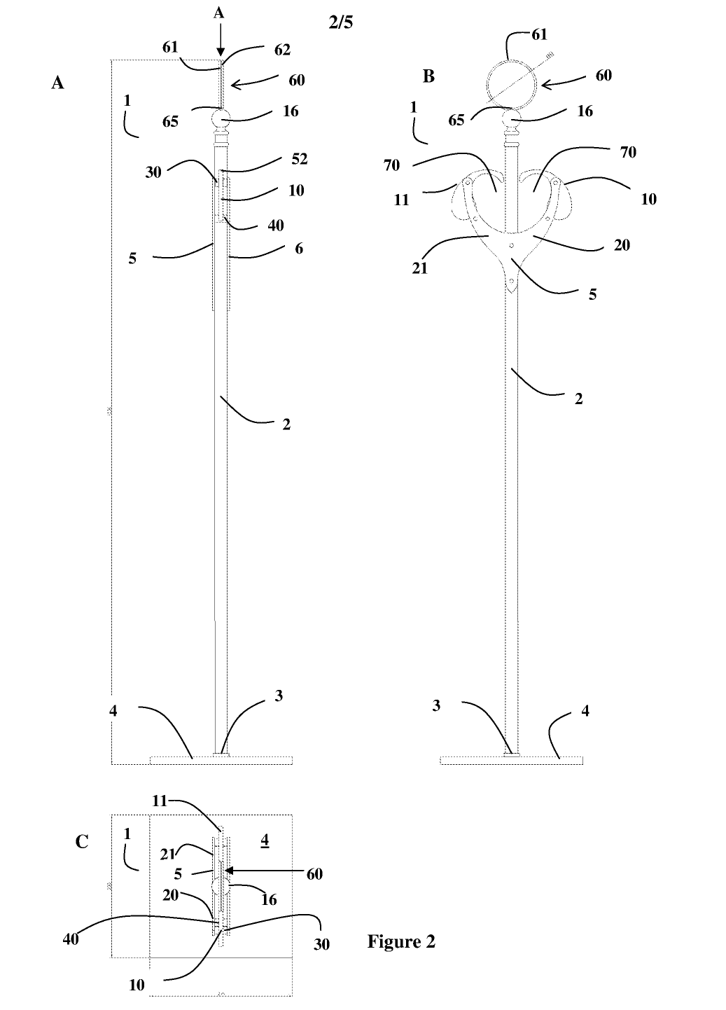

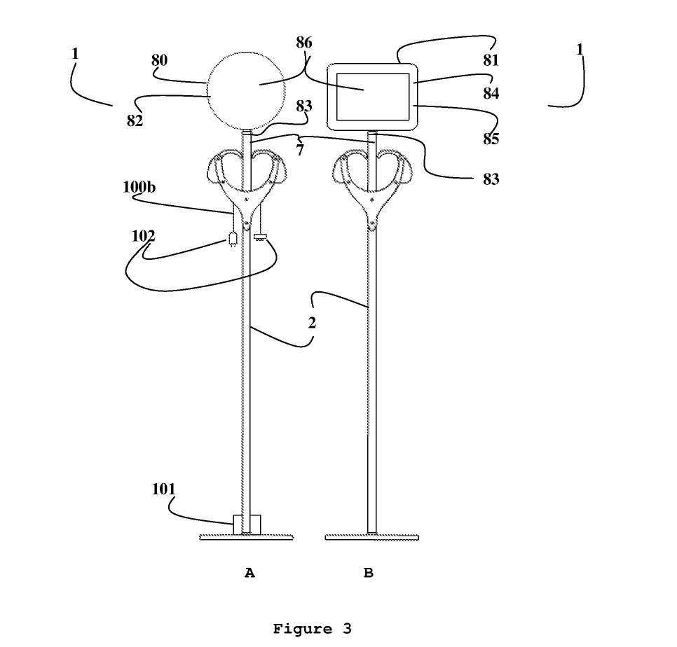

In FIGS. 2A-C, there is shown a stand of the present invention as illustrated in FIG. 1 with a receiving means 60 attached to the object 16 on plinth 15. The receiving means 60 as shown in the FIG. 2 is a pair of hoops 61, 62 joined together at a point 65 which also acts to secure the receiving means 60 to the object 16. The receiving means 60 is suitable for accommodating a menu, an advertising board or other commercial pamphlet via a gap A between the pair of hoops 61, 62. Further variations of the receiving means 60 are shown in FIGS. 3A and 3B.

In use when securing a bag, (it will be understood here for demonstration purposes that only one clip will be used) the user pushes down on the end 52 of the clip 10 in the direction of arrow B which in turn raises the end 50 in the direction of arrow C. The movement of the clip 10 opens the secure compartment 70 to enable the user to place a handle of the bag into the secure compartment 70. The handle of the bag is placed on the arm 20 and the user releases the pressure placed on end 52. Due to the weighted nature of end 50, the end 53 of the clip 10 returns to its biased position juxtaposed the pole 2. To remove the bag strap from the arm 20, the user has to first push down on the end 52 of the clip 10 with one hand and with the other hand removes the bag from the secure compartment 70.

In FIGS. 3A and 3B there is shown a front view of a further embodiment of the stand of the present invention. In the illustrated embodiment, the plinth 15 is absent and a receiving means 80, 81 is attached to the top end 7 of the pole 2. The receiving means 80 comprises a disk 82, as shown in FIG. 3A, secured to the top end 7 of the pole 2 by a connection means 83. The connection means 83 may comprise any mating connections known to the skilled person such as screw, a bolt, spot welding, or clips. The receiving means 81 illustrated in FIG. 3B comprises a rectangle 84 having an outer edge 85, which is secured to the top end 7 of the pole 2 by a connection means 83. The receiving means 80, 81 each accommodate two pieces of PMMA glass 86 or other transparent material. The PMMA glass 86 are kept parallel to and away from each other in receiving means 80,81 forming a gap there between within which a menu, an advertising board or other commercial pamphlet can be accommodated.

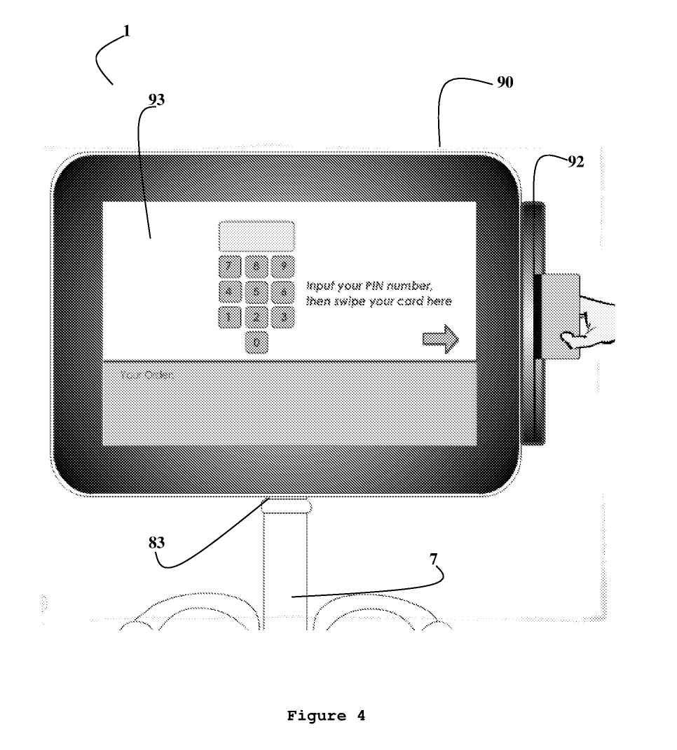

In FIG. 4 there is shown a front view of a further embodiment of the present invention. In the illustrated embodiment, the plinth 15 is absent and a Liquid-Crystal Display (LCD) 90 is attached to the top end 7 of the pole 2. The LCD 90 is secured to the top end 7 of the pole 2 by a connection means 83, such as a bracket, having an aperture therein to accommodate a power cable connected to a power supply which connects to and powers the LCD 90. The LCD 90 is configured with an electronic slotted card swipe 92 for use in making electronic transactions and an interactive display 93.

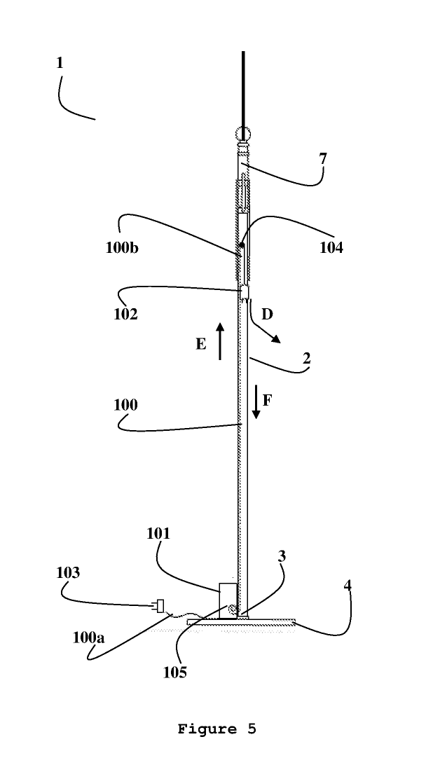

In FIG. 5 there is shown a side view of a further embodiment of the present invention. In the illustrated embodiment, there is provided a power cable 100 threaded through a cavity in the pole 2 which runs from the bottom end 3 of the pole 2 to the top end 7 of the pole 2. The cable 100 is wound around a spring-loaded spool 105 located within a storage box 101 (also illustrated in FIG. 3A). The cable 100 leaves the storage box 101 as cable 100a to which there is connected a plug 103 configured to engage with a wall power point or socket or power supply. The cable 100 exits the cavity of the pole 2 as cable 100b through an aperture 104 in the top end 7 of the pole 2 (also illustrated in FIG. 3A). Attached to the cable 100b there is a connection 102 configured to matingly engage with an electronic device such as a computer, laptop, or mobile communications device (also illustrated in FIG. 3A).

When a user wishes to matingly engage the connection 102 with an electronic device, the connection 102 is pulled in the direction of arrow D and the power cable 100 extends from the spool 105 in the direction of arrow E. When the user has finished charging their electronic device, the connection 102 is disconnected from the device and the power cable 100 retracts in the direction of arrow F and wraps around the spool 105 for storage. The aperture 104 is of a diameter such that the connection 102 is unable to fit through the aperture 104 and into the cavity of the pole 2.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiment hereinbefore described, which may be varied in construction and detail without departing from the spirit of the invention.

1. A bag stand for securing a bag comprising a base, a pole connected to the base, and a means for securing the bag, wherein the means for securing the bag is attached to the pole,
wherein the means for securing the bag comprises at least one supporting means having a pair of clips pivotally secured thereto.

2. A bag stand according to claim 1 wherein the supporting means comprises a plate having a pair of outwardly curving arms.

3. A bag stand according to claim 2 wherein the arms are positioned away from the pole at an angle between about 15° and 75° relative to the vertical axis of the pole.

4. A bag stand according to any of claim 1 wherein the means for securing the bag comprises a pair of juxtaposed plates secured together either side of the pole.

5. A bag stand according to claim 2 wherein the clips are arcuate having a teardrop-like lobe at a first end and a thin lobe at a second end.

6. A bag stand according to claim 2, wherein the clips are arcuate having a teardrop like lobe at a first end and a thin lobe at a second end and wherein the teardrop-like lobe is weighted.

7. A bag stand according to claim 4, in which the pair of plates are further secured together by a stop positioned between the arms, and wherein the stop acts to prevent the weighted teardrop-like lobe of the clip from reaching its gravitational equilibrium along the clip's longitudinal (X)-axis.

8. A bag stand according to claim 4 in which the pair of plates are further secured together by a stop positioned between the arms, and wherein the stop acts to prevent the weighted teardrop-like lobe of the clip from reaching its gravitational equilibrium along the clip's longitudinal (X)-axis and wherein when the weighted teardrop-like lobe rests against the stop, the thin lobe of the clip is juxtaposed the pole of the stand.

9. A bag stand according to claim 4, wherein the combination of the plate, the arm, the clip and the pole form a space-defining secure compartment within which the bag may be secured.

10. A bag stand according to claim 1, wherein the stand further comprises a receiving means secured to the top of the pole.

11. A bag stand according to claim 1, wherein the stand further comprises a receiving means secured to the top of the pole and in which the receiving means is adapted to accommodate a menu, an advertising board for advertising goods and services, or a commercial pamphlet.

12. A bag stand according to claim 1, wherein the stand further comprises a liquid-crystal display adapted to be secured to the top of the pole.

13. A bag stand according to claim 1, wherein the stand further comprises a liquid-crystal display adapted to be secured to the top of the pole and wherein the liquid crystal display is an interactive liquid crystal display and further comprises an electronic slotted card swipe adapted for use in facilitating electronic transactions.

14. A bag stand according to claim 1, wherein the stand further comprises at least one power cable connected to a power supply and configured for engaging with and charging an electronic device.
